(19) United States
(12) Patent Application Publication
(10) Pub. No.: US 2025/0277626 A1
(43) Pub. Date: Sep. 4, 2025

(54) Heating Element for a Furnace for Firing or Sintering Workpieces, and Furnace Having at Least One Such Heating Element

(71) Applicant: Vita Zahnfabrik, Bad Säckingen (DE)

(72) Inventor: Thomas Baholzer, Bad Säckingen (DE)

(21) Appl. No.: 18/858,604

(22) PCT Filed: May 4, 2023
(86) PCT No.: PCT/EP2023/061846

§ 371 Date: Oct. 21, 2024

(30) Foreign Application Priority Data
May 4, 2022 (DE) 10 2022 001 561.7

(51) Int. Cl. F27B 17/02; H05B 3/00; H05B 3/08; H05B 3/44; H05B 3/64

(52) U.S. Cl. CPC F27B 17/025; H05B 3/0033; H05B 3/08; H05B 3/44; H05B 3/64; H05B 2203/032

(57) ABSTRACT

The invention relates to a heating element (7) for a furnace, which heating element comprises a sapphire glass tube (8) for receiving a heating coil (17) inside the sapphire glass tube (8). The sapphire glass tube (8) is gas-tightly connected to a borosilicate tube (14) and also to a quartz glass tube (15). The electrical connections at the ends lead through in a gas-tightly compressed manner. According to the invention, the tube element is made of sapphire (8) and is gas-tightly joined by transition glasses and glass solder to compensate for the different coefficients of thermal expansion. The joined elements (14, 15) are located outside the firing chamber (2) so that they ensure operational reliability in the case of a thermal effect of up to 500° C. Furthermore, for firing/sintering the ceramic element (4) with shortwave infrared radiation in the range of from 0.8 μm to 2.5 μm, the heating element (7) has stable optical, electrical and mechanical properties and thus high-quality, permanently uniform firing and sintering results are ensured with significantly shortened firing-sintering times. No changes to the surface of the heating elements (7) occur which are caused by chemical influences or evaporations from the fired-sintered elements. No contamination of the sintered objects and the firing chamber occurs which is caused by the heating element (7). The heating element (7) can be used at an operating temperature up to 1900° C. and thus ensures use over long uptimes.

The invention relates to a heating element for a furnace for firing and/or sintering workpieces, especially workpieces made of dental-ceramic materials, and a furnace for firing and/or sintering workpieces, especially workpieces made of dental-ceramic materials.

Fields of application of the invention include the sintering or firing of workpieces that can be employed in a wide variety of industrial fields, such as gears and other elements that can be employed, in particular, in the automobile industry. Another focus of the use of the invention is found in the dental branch. In this field, zirconium oxide and other dental-ceramic compounds based on dental alloys are sintered and fired as metal-free dentures, especially from zircon and/or other ceramic materials.

In dental furnaces that are used for firing and/or sintering veneer ceramics with or without glaze paints of for glaze firing, electric resistance heatings are known in which a heating wire, preferably made of Kanthal and incorporated in a quartz tube, is used. However, such known heating elements can be employed only up to a maximum of 1200° C.

Other known dental furnaces are described in WO 2018/011061 A1 and WO 2020/088943 A1.

For sintering zirconium oxide (SiO₂), which has increasingly been employed in recent years in dental restorations, a temperature of 1650° C. is required.

For commercially available dental furnaces for the firing and/or sintering of metal-free dentures, such as zirconium oxide ceramics or similar materials, three different heating systems are known, namely
1. heating systems with molybdenum disilicide (MoSi₂ heating systems),
2. heating systems with silicon carbide (SiC), and
3. heating systems using induction

### Item 1. Molybdenum Disilicide

Molybdenum disilicide is a dense metal-ceramic material consisting of molybdenum disilicide and an oxide fraction, mainly a glass phase. This glass fraction or this protection layer changes during the heating phases, resulting in spallings and thus in a contamination of the object to be sintered (workpiece) and/or of the firing compartment. The spallings are clearly seen in the form of small glass splinters and glass dust.

After some firing cycles, this requires a so-called cleaning firing over a period of more than four hours at a temperature of more than 1400° C. without the furnace being charged, which implies a considerable expenditure of time and energy.

The cleaning firing has to be performed without objects to be sintered a number of times until a uniform protection layer can again be seen at the molybdenum disilicide heating elements.

The dissolving of the oxide layer at the heating element results in the formation of MoO₃ (molybdenum(VI) oxide), also referred to as “pest oxidation”, which in turn results in an undesirable discoloration to green-yellow of the restorations (workpieces).

In order to protect objects to be sintered from contamination/discoloring, the use of a sintering shell covering the workpiece is required.

Also, the molybdenum disilicide heating elements become very sensitive to breakage after a short service time, while they are stressed to the maximum range of use in a temperature range of up to 1650° C., so that failures usually occur after short service times.

### Item 2. Silicon Carbide

Silicon carbide heating rods have an unfavorable temperature-resistance performance, so that a very complicated thyristor-controlled closed-loop control is required. In addition, it has to be taken care that exclusively those rods are connected that have the same electric resistance and the same state of ageing. This results in the fact that single defect heating rods in a system cannot be replaced. In such a case, the entire heating system has to be replaced.

Silicon carbide heating rods are expensive and highly sensitive to breakage. Replacing them causes high spares costs as compared to other heating systems. As mentioned above, when one silicon carbide heating element fails, the complete system has to be replaced, since heating elements that are connected must have the same electric resistance. Otherwise, failures of other heating elements will follow within a very short period of time. The replacement of all heating elements in turn involves even higher costs.

### Item 3. Induction

It is known to operate dental furnaces by means of induction for sintering workpieces. An induction furnace has an induction coil. Induction coils are also referred to as “inductors”. They are usually water-cooled, which is a disadvantage if used in a dental laboratory or in a dental practice. The inductor through which a current flows produces a time-varied magnetic field, which results in the workpieces being controllably heated by means of eddy currents.

Since the materials used in the dental field are non-conductive, a susceptor has to be additionally employed, i.e., an element that has the property to absorb electromagnetic energy, convert it to heat, and pass it on to the workpiece by convection.

Since the inductors have to be well matched to the properties of the materials to be treated in order to achieve the desired thermal behavior, the possible uses of the different non-conducting materials in dental technology are limited, especially with regard to the size of the workpieces.

The size of the firing compartment in the known induction furnaces is about a maximum of 3 crowns, i.e., a length of 38 mm and a height of 20 mm must not be exceeded.

Because of the high interference emission, extensive safety regulations are to be observed. For example, induction furnaces must not be used in the patients' environment.

Only a limited set of materials are allowed for the thermal treatment of workpieces by induction.

It has been the object of the invention to provide a heating element for sintering and/or firing furnaces that is characterized by a high effectiveness and high temperature tolerance.

This object is achieved by the invention, which provides a heating element for a furnace for firing and/or sintering workpieces, especially of workpieces made of dental-ceramic materials, being equipped with
a sapphire glass tube, and
a heating coil made of tungsten and/or molybdenum that is provided in the sapphire glass tube and has connection leads routed to the outside,
wherein the ends of the sapphire glass tube are closed in a gas-tight manner by closures, especially made of quartz glass, and
wherein the connection leads of the heating coil are routed to the outside through the closures, especially closures made of quartz glass.

Analogously, the invention relates to a heating element whose heating coil is made of tungsten and whose connection leads contain molybdenum and which is arranged within a sapphire glass tube. The material of this glass tube is synthetic sapphire, i.e., an aluminum oxide with a purity of 100%.

At its both ends, the sapphire glass is closed in a gas-tight manner by, in particular, quartz glass or another heat resistant or thermally resistant material, wherein the connection leads of the heating coil pass in a gas-tight manner through the two closures. Hereinbelow, the material for these closures is referred to as “quartz glass” for the sake of simplicity. A piece of quartz glass tube that is “tight-squeezed” at its end facing away from the sapphire glass tube is used. The material of this piece of quartz glass tube is also a synthetic one, which, unlike the synthetic sapphire material, can be worked in a softened state, namely to enable a gas-tight closure by compressing (squeezing) when the connection lead passes through it.

The sapphire glass tube and the pieces of quartz glass tube are joined together. Preferably, for a better transition between the materials sapphire and quartz having different temperature coefficients, a borosilicate intermediate piece is respectively arranged between the two. This borosilicate tubular piece is also joined, i.e., connected in a gas-tight way, with the sapphire glass and the quartz glass closure. Corresponding joining techniques are known in the prior art. Thus, for example, the joining can be achieved by a glass solder or the like glass materials. By the stepwise adaptation to the different thermal expansion coefficients, the thermally caused changes in length resulting therefrom can be compensated. Thermal or mechanical stresses and cracking in and between the individual glass materials sapphire, quartz and borosilicate are avoided thereby, and a vacuum tightness or leaking rate of 10⁻⁸ mbar*l/s is ensured.

In the built-in state of the heating element in a furnace, it is convenient if the intermediate tubular pieces of borosilicate or, if the latter is not present, the quartz glass closures are provided outside the firing chamber of the furnace. In addition, it is possible to cool such intermediate tubular pieces and quartz glass closures, so that the occurrence of stresses is highly reduced.

The zones of the heating element provided outside the firing chamber are vacuum-tight within a temperature range of up to 500° C., and have a leaking rate of only 10⁻⁸ mbar*l/s.

The melting temperatures of the materials tungsten and molybdenum, which are employed for the heating coils and the supply lines, are above 2000° C. to 2500° C. Thus, in this respect, these materials are suitable for use as heating coils of the heating element according to the invention. The heating coil is made of tungsten, in which the coil is electrically connected at its ends through a molybdenum intermediate piece each with an electric conductor made of a common electrically conducting material, preferably one having an increased temperature resistance.

According to an advantageous embodiment of the invention, it may be provided that the heating coil emits electromagnetic radiation in the near infrared range of from 0.8 μm to 5 μm, or from 0.8 μm to 2.5 μm, and that the sapphire glass tube is transparent to said electromagnetic radiation in a range of from 0.17 μm to 6 μm.

As mentioned above, with respect to the adapting of the different temperature coefficients, it is advantageous if an intermediate tubular piece made of borosilicate is respectively provided in a gas-tight manner between the quartz glass closures and the ends of the sapphire glass tube.

in another advantageous embodiment of the invention, it is provided that the sapphire glass tube and, if any, the intermediate tubular piece of borosilicate are filled with a noble or other inert gas.

Further advantages of the heating element according to the invention can be seen in the fact that the heating element, when operated with the proper current, emits electromagnetic radiation by a quick response (the time from the “cold” state of the heating element to the reaching of its radiation maximum is preferably a few seconds, especially less than 10 seconds, or less than 5 seconds, or less than 3 seconds), and further no contaminations are caused on the workpiece, and in addition, it is not contaminated even by substances of the workpiece or substances caused thereby in the sintering and/or firing, such as vapors from coatings on the workpiece, such as glaze compositions.

In one embodiment of the invention, the heating coil is made of tungsten, wherein the ends of the heating coil are connected through intermediate electric conductors made of molybdenum with electric conductors made of a material other than molybdenum, and/or wherein the molybdenum intermediate conductors extend through the closures of the sapphire glass tube.

The closures at the ends of the sapphire glass tube are made of a heat-resistant material, whose coefficient of thermal expansion approximately corresponds to that of molybdenum. It is convenient that the molybdenum intermediate conductors extend through these closures. Quartz glass is particularly suitable here. Other combinations of materials are also conceivable, which is why the invention is not limited to quartz glass as a closure material for the sapphire glass tube and molybdenum as an intermediate electric conductor. The intermediate electric conductor extends through the “squeezed” portion of the closure, i.e., it should essentially have the same thermal expansion coefficient as the closure material, so that thermal stresses and cracking cannot occur.

The heating element according to the invention can be employed in a furnace according to the invention, in whose firing chamber said heating element is incorporated, preferably in such a manner that the quartz glass closures are provided outside the firing chamber. Conveniently, the heating element is guided through opposite openings in the wall of the firing chamber through screw connections or the like fixing elements. These passages in the wall of the firing chamber for the heating element are sealed in a gas-tight manner, so that a vacuum can be produced inside the firing chamber.

In a convenient embodiment of the invention, at least one reflection element can be provided in the firing chamber, in order to direct the electromagnetic radiation emitted by the heating element towards the workpiece.

In the above described embodiment of the invention, it may further be provided that said heating element is partially surrounded by said reflector element, and/or that said reflector element has a semicircular design in cross-section, and preferably extends over the entire length of a related heating element, and/or that the chamber walls to be formed in the firing chamber have a high thermal insulation.

In a preferred embodiment of the invention, the furnace has a receiving element provided in the firing chamber for receiving the workpiece, wherein said receiving element has a radiation-absorbing material, which absorbs radiation, in particular, and thus acts as a susceptor element, which, being e thermal radiator, transfers thermal energy to the workpiece.

In a convenient embodiment of the invention, said receiving element contains silicon carbide.

In another advantageous embodiment of the invention, it is provided that a temperature measuring means is provided in the firing chamber close to the ceramic element to be fired.

In a convenient embodiment of the invention, a temperature measuring means sensing the temperature in the zone of the workpiece is provided.

With the heating element according to the invention, it is possible to operate sintering or firing furnaces at extremely high temperatures of at least 1900° C., in which the furnace can be employed in permanent operation in this temperature range, so that long service lives can be achieved. Thus, in furnaces equipped in this way, both general ceramic firing and sintering processes can be performed at extremely high temperatures under atmospheric pressure or in a vacuum. Especially in “firing with sintering” processes in a temperature range of about 1600° C., high demands are put on the heating element. Because of the use of sapphire glass, the heating element according to the invention meets the properties of reliability, long service life, promptness, cleanliness, energy saving property, and a high heat radiation provided in a short time. According to the invention, this is achieved by using the sapphire glass tube and the heating coil made of tungsten and the molybdenum transitions.

The physical properties of synthetic sapphire glass meet all the necessary requirements put on the resistance against aggressive acids and vapors, the density (important to gas tightness), hardness, and compressive strength.

The temperatures necessary for technical and dental sintering processes of about 1600° C. are significantly below the melting point of about 2050° C., which is critical for sapphire glass. Thus, the sapphire glass tube resists the firing chamber temperatures of up to 1900° C. as provided according to the invention.

Another relevant property of sapphire is its transmittance, i.e., the transparency for electromagnetic radiation of the heating coil within a range of from 0.8 μm to 2.5 μm, so that the firing and sintering process can take place in an extremely short time. The radiation range in a wavelength range of below 2 μm has the property of a greater penetration depth into the workpiece, so that high quality results can be achieved in an extremely short time. The heat energy gets to the workpiece virtually exclusively by radiation; heat convection is irrelevant.

Another advantage of the invention can be seen in the fact that the use of the heating element and the physical properties of the sapphire glass tube provide for an excellent transmission in the short-waved infrared range of from 0.8 μm to 2.5 μm.

It is further advantageous that the sapphire glass tube is excellently resistant against chemical and aggressive media, has excellent optical as well as mechanical and thermal properties, and thus, no limitations or changes in the quality of the result of the firing and/or sintering process are seen even with permanent stresses.

Finally, it may also be noted as an advantage that said acting of the short-waved infrared radiation of from 0.8 μm to 2.5 μm on the workpiece and the associated great penetration depth of the radiation into the workpiece achieve an essentially shorter firing and/or sintering time. This in turn significant reduces the energy expenditure.

Hereinbelow, the invention is explained in more detail by means of an Example and with reference to the drawing. In detail:

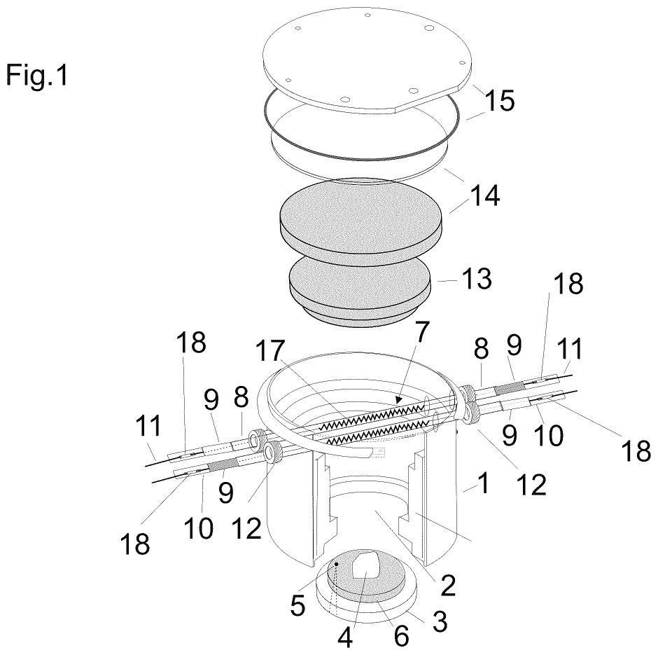

FIG. 1 shows a simplified view of the essential components of a firing and/or sintering furnace in an exploded and perspective view, and

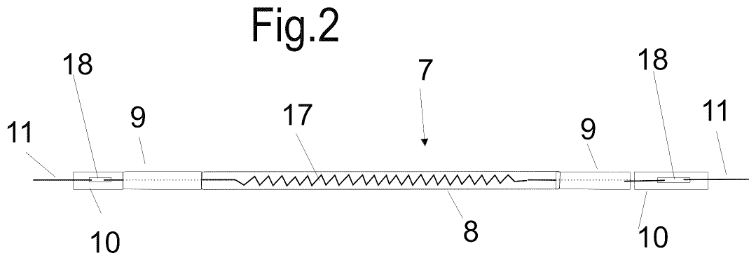

FIG. 2 shows a side view on the heating element according to an Example.

In the following, the invention is described by means of the use of two heating elements in one dental furnace. However, the invention is not limited to the use in dental furnaces. Also, more or less than two heating elements 7 could be employed in one furnace.

A dental furnace has a housing 1 with a firing chamber 2. The interior of the housing 1 is equipped with a high temperature insulation 6, and provided with further refractory insulation elements 13, 14, and with an element functioning as a reflector 13. Further, the housing 1 is closed with a lid and a seal ring 15.

In the Example shown, two heating elements 7 are provided in the firing chamber 2. Each of the two heating elements 7 is pushed into the firing chamber 1 through a passage opening and fixed therein with vacuum-tight screw connections 12, which are provided in the housing 1. In the mounted state, the screw connections 12 surround and fix the corresponding heating element in a vacuum-tight manner.

The glass tubes 9 made of synthetic borosilicate and 10 made of synthetic quartz glass of heating element 7 with its leads 11 for the operating voltage lie outside the firing chamber 1, so that, for example, the quartz tube 10 joined by glass solder is compressed in a gas-tight manner with the connection of the heating coil 17 with the molybdenum connection lead 11, which is guided outside.

The design of the heating element is shown in FIG. 2. In the represented Example, the sapphire glass tube 8 is joined at both ends in a gas-tight manner to each borosilicate intermediate tubular piece 9, which is in turn further joined in a gas-tight manner to said squeezed quartz glass tube 10. In the quartz glass tube 10 gas-tightly joined at the ends, the heating coil 17, which extends through the borosilicate intermediate tubular pieces 9, is connected through molybdenum intermediate pieces 18 with the connection leads 11, leading outside, which are compressed in a gas-tight manner by means of the squeezed part.

Using a firing stage 3 (FIG. 1) and a temperature sensor 5, it is possible to introduce the dental ceramic to be fired and/or sintered (workpiece 4), which has been placed on the firing stage 3, into the firing chamber 2. The temperature of the firing chamber 2 is closed-loop-controlled by the temperature sensor 5 and the corresponding electronic controller (not shown).

1. A heating element for a furnace for firing and/or sintering workpieces, the workpieces made of dental-ceramic materials, comprising
a sapphire glass tube (8), and
a heating coil (17) made of tungsten and/or molybdenum, which is provided inside said sapphire glass tube (8), and has connecting leads (11) leading outside,
wherein the ends of the sapphire glass tube (8) are sealed in a gas-tight manner by means of closures made of a heat-resistant material, and
wherein the connecting leads (11) of the heating coil (17) are guided outside through the sapphire glass tube closures (10).

2. The heating element according to claim 1, characterized in that the heating coil (17) emits electromagnetic radiation in the near infrared range of from 0.8 μm to 5 μm and that the sapphire glass tube (8) is transparent to said electromagnetic radiation in a range of from 0.17 μm to 6 μm.

3. The heating element according to claim 1, characterized in that an intermediate tubular piece (9), which is made of a heat-resistant material having a coefficient of thermal expansion that is between that of sapphire glass and that of the closure material of the sapphire glass tube (8), is respectively provided in a gas-tight manner between the sapphire glass tube closures (10) and the ends of the sapphire glass tube (8).

4. The heating element according to claim 1, characterized in that the sapphire glass tube (8) and, optionally, the intermediate tubular pieces (9) of borosilicate are filled with a noble or other inert gas.

5. The heating element according to claim 1, characterized in that the heating element (7), when operated with the proper current, emits electromagnetic radiation by a quick response, and further no contaminations are caused on the workpiece (4), and in addition, it is not contaminated even by substances of the workpiece (4) or substances caused thereby in the sintering and/or firing.

6. The heating element according to claim 1, characterized in that the heating coil (17) is made of tungsten, and that the ends of the heating coil (17) are connected through intermediate electric conductors made of molybdenum with electric conductors made of a material other than molybdenum, and/or that the molybdenum intermediate conductors (11) extend through the closures of the sapphire glass tube (8).

7. A furnace for firing and/or sintering workpieces, the workpieces made of dental-ceramic materials, comprising
a firing chamber (1), and
at least one heating element (7) according to claim 1, provided within said firing chamber (1).

8. The furnace according to claim 7, characterized in that at least one reflection element (13) is provided in said firing chamber (1), in order to direct the electromagnetic radiation emitted by the heating element (7) towards the workpiece (4).

9. The furnace according to claim 7, characterized in that said heating element (7) is partially surrounded by said reflector element (5).

10. The furnace according to claim 7, characterized in that said reflector element (13) has a semicircular design in cross-section.

11. The furnace according to claim 7, characterized in that the chamber walls (6, 13, 14) to be formed in the firing chamber (1) have a high thermal insulation.

12. The furnace according to claim 7, characterized by a receiving element (3) for receiving said workpiece (4), provided in said firing chamber (1), wherein said receiving element (6) has a radiation-absorbing material, which absorbs radiation, and thus acts as a susceptor element, which, being a thermal radiator, transfers thermal energy to the workpiece (4).

13. The furnace according to claim 12, characterized in that said receiving element (6) comprises silicon carbide.

14. The furnace according to claim 7, characterized in that a temperature measuring means (5) is provided in the firing chamber (2) close to the ceramic element (4) to be fired.

15. The furnace according to claim 7, characterized by a temperature measuring means (5) sensing the temperature in the zone of the workpiece (4).

16. The heating element according to claim 1, wherein the heat-resistant material comprises quartz glass closures (10).

17. The heating element according to claim 2, characterized in that the heating coil (17) emits electromagnetic radiation in the near infrared range of from 0.8 μm to 2.5 μm.

18. The heating element according to claim 3, wherein the sapphire glass tube (8) comprises borosilicate.

19. The heating element according to claim 5, wherein substances caused thereby in the sintering comprises vapors from coatings on the workpiece.

20. The furnace according to claim 10, wherein the semicircular design in cross-sections extend over the entire length of a related heating element (7).
